(19) United States
(12) Patent Application Publication
(10) Pub. No.: US 2009/0210556 A1
(43) Pub. Date: Aug. 20, 2009

(54) Time division address management device and time division routing information management device

(75) Inventor: Toshihiko Yamakami, Chiba (JP)

Correspondence Address: MORRISON & FOERSTER LLP, 425 MARKET STREET, SAN FRANCISCO, CA, 94105-2482, US

(73) Assignee: ACCESS CO., LTD, CHIYODA-KU (JP)

(21) Appl. No.: 11/921,387

(22) PCT Filed: May 30, 2006
(86) PCT No.: PCT/JP2006/311173

§ 371 Date: Nov. 30, 2007

(30) Foreign Application Priority Data
May 31, 2005 (JP) 2005-158620

(51) Int. Cl. G06F 15/173; H04L 29/08

(52) U.S. Cl. 709/242

(57) ABSTRACT

There is provided an address management device, which includes an address storage unit configured to store an address used for communication for a local network and a global address used for communication for a global network, an address switch judgment unit configured to judge timing for switching between the address for the local network and the global address, and an address switch unit configured to switch between the address for the local network and the global address in accordance with a judgment result of the address switch judgment unit.

### FIELD OF THE INVENTION

The present invention relates to a management device for managing addresses or routing information for terminal devices used in grovel and local network environments.

### BACKGROUND OF THE INVENTION

Conventional networks include an infrastructure type network in which each terminal device is constantly connected to the network and, an ad hoc network which is established temporarily when a group of terminals get together.

The infrastructure type network are classified into a global network in which global IP addresses are respectively assigned to terminal devices, and a local network such as a LAN (Local Area Network) in which local IP addresses are assigned to terminal devices in the local network which is typically established in closed space. In general, a terminal device in a local network is able to send/receive information to/from the global network through a router having a function of address conversion. The ad hoc network utilizes short-range wireless communication as in the case of Bluetooth®, Zigbee® or wireless LAN configured to establish a network among terminal devices within a predetermined communication range.

In the infrastructure type network (i.e., the global or local network), address management is achieved by respectively assigning unique IP addresses to terminal devices. On the other hand, in the ad hoc network (e.g., Bluetooth® or Zigbee®), address management is achieved using a management manner different from the IP address-based management.

In a field of research and development of information home appliance networks, i.e., ubiquitous networks, attempts to network information home appliances are now being made. Since wireless communications are preferable as communication means to be used by information home appliances, a short-range wireless communication such as Bluetooth® or Zigbee®, which is able to achieve low cost and low power networks, is becoming a promising candidate for a wireless network to be used for information home appliances.

Recent sensor technology enables a small device such as a wireless IC tag to be mounted on various types of information home appliances, thereby providing technology for embedding networks and computers in real world which is called “real world computing”, as described in “Ubiquitous Sensor Network”, Shiro Sakata, Internet magazine No. 3, page 64-65, 2005.

In the field of Information home appliance network using the above mentioned short-range wireless communication, an attempt to connect a number of chips (including IC tags), which can be provided in information home appliances and in various locations in an office and can be networked, to a global network has been made. However, to connect the chips to a global network is very difficult in regard to cost and technology because of the limitation of practical power supplying techniques and the limitation of resources such as CPU and memory.

Therefore, it is requested to principally use an ad hoc network utilizing short-range wireless communication as an information home appliance network. It is difficult for devices capable of only performing shortrange wireless communication to transmit/receive information to/from a global network.

It is said that IPv6 proposed in the middle of 1990's is able to solve the above mentioned issues. IPv6 makes it possible to assign global addresses to all of the devices. However, IPv6 requires a heavy load on each device and is vulnerable to an invasion from the outside. That is, IPv6 is low-security. For example, IPv6 may undergo DDoS attack (Distributed Denial of Service Attack). Therefore, to use IPv6, particular safety measures are required.

Assuming a situation where a user operates the user's remote controller of an information home appliance capable of performing IPv6-based communications, a user may have uncomfortable feeling when the response to a user operation is delayed depending on the condition of communication traffic. In such a situation, an ad hoc network is more convenient for information home appliances than an IPv6-based network, as described in “Professor Sakamura of TRON Addresses Misunderstanding of Ubiquitous” of IT media web site

“http://www.itmedia.co.jp/broadband/0212/20/tron.html”, on IT comprehensive information site.

It is possible to temporarily assign an IP address to an information home appliance on an as needed basis using a technology of DHCP (Dynamic Host Configuration Protocol) so as to enable the information home appliance to perform communications through a global network. In this case, the degree of vulnerability of security may be lowered because the information home appliance is not constantly connected to the global network. However, the information home appliance is only able to use an IP address temporarily. Therefore, if the obtained IP address is returned, the information home appliance is unable to perform short-range wireless communication based on an ad hoc network. There is thus a demand for a technology for an effective network management in regard to a local network such as an information home appliance network.

### SUMMARY OF THE INVENTION

The present invention is advantageous in that it provides an address management device capable of managing network addresses of devices while utilizing both of the advantages of a global network and a local network.

According to an aspect of the invention, there is provided an address management device, which is provided with an address storage unit configured to store an address used for communication for a local network and a global address used for communication for a global network, an address switch judgment unit configured to judge timing for switching between the address for the local network and the global address, and an address switch unit configured to switch between the address for the local network and the global address in accordance with a judgment result of the address switch judgment unit.

With this configuration, it is possible to form a network system reflecting advantages of both of the local and global networks while achieving a high level of security.

In at least one aspect, the address switch judgment unit judges the timing for switching between the address for the local network and the global address in accordance with time information.

In at least one aspect, the address management device includes a time judgment unit configured to manage time, to receive a time from a wired or wireless network, and to adjust the managed time in accordance with the time received from the wired or wires network. The time information is provided by the time judgment unit.

In at least one aspect, the address switch judgment unit judges the timing for switching between the address for the local network and the global address in accordance with condition information.

In at least one aspect, the address switch judgment unit judges an address to be changed to the global address for a predetermined time period in accordance with the condition information, and notifies an external device of secret information containing a time at which the address switch judgment unit is scheduled to switch an address to be used to the global address during the predetermined time period.

In at least one aspect, wherein the address switch judgment unit notifies an external device of a time at which the address switch judgment unit is scheduled to switch an address to be used to the global address by repeatedly switching between the address for the local network and the global address at predetermined time intervals in a predetermined time period.

In at least one aspect, the address management device includes a dynamic address acquisition unit configured to obtain a tentative global address to be used as the global address.

In at least one aspect, the address storage unit includes a first storage unit storing the address used for communication for the local network, and a second storage unit storing the global address.

According to another aspect of the invention, there is provided a communication system including a local network in which a plurality of terminal devices having functions of communicating with each other in the local network are provided. The plurality of terminal devices include first and second terminal devices. The first terminal device includes an address storage unit configured to store an address used for communication for the local network and a global address used for communication for a global network, an address switch judgment unit configured to judge timing for switching between the address for the local network and the global address, and an address switch unit configured to switch between the address for the local network and the global address in accordance with a judgment result of the address switch judgment unit. In this configuration, the second terminal device is configured to transmit data for communication for the global network to the first terminal device, and the first terminal device outputs the data from the second terminal device to the global network during a time in which an address to be used is kept at the global address by the address switch unit.

With this configuration, it is possible to form a network system reflecting advantages of both of the local and global networks while achieving a high level of security.

In at least one aspect, the address switch judgment unit of the first terminal device judges the timing for switching between the address for the local network and the global address in accordance with time information.

In at least one aspect, the first terminal device includes a time judgment unit configured to manage time, to receive a time from a wired or wireless network, and to adjust the managed time in accordance with the time received from the wired or wires network. The time information is provided by the time judgment unit.

In at least one aspect, the address switch judgment unit of the first terminal device judges the timing for switching between the address for the local network and the global address in accordance with condition information.

In at least one aspect, the second terminal device includes a routing unit configured to perform routing for the first terminal device when the second terminal device transmits the data for communication for the global network to the first terminal device.

In at least one aspect, the routing unit performs the routing based on time information.

In at least one aspect, the routing unit performs the routing based on condition information.

According to another aspect of the invention, there is provided a communication system including a plurality of local networks each of which includes a plurality of terminal devices having functions of communicating with each other in each local network. The plurality of terminal devices including first and second terminal devices. The first terminal device includes an address storage unit configured to store an address used for communication for the local network and a global address used for communication for a global network, an address switch judgment unit configured to judge timing for switching between the address for the local network and the global address, and an address switch unit configured to switch between the address for the local network and the global address in accordance with a judgment result of the address switch judgment unit. In this configuration, the second terminal device is configured to transmit data for communication for the global network to the first terminal device, and the first terminal device outputs the data from the second terminal device to the global network during a time in which an address to be used is kept at the global address by the address switch unit.

With this configuration, it is possible to form a network system reflecting advantages of both of the local and global networks while achieving a high level of security.

In at least one aspect, the first and second terminal devices in one of the plurality of local networks transmit data for communication for the global network to the first terminal device in another local network.

In at least one aspect, each of the first and second terminal devices in one of the plurality of local networks includes a routing unit configured to perform routing by determining which of the first terminal devices in the plurality of local networks should be targeted for transmission of data for communication for the global network.

In at least one aspect, a first local network of the plurality of local networks is connected to the global network only by intervention of a second local network of the plurality of local networks. In this case, the first terminal device of the first local network is connected to the global network in time zones at which time zones when the first terminal device in the first local network is to scheduled to use the global address and times zones when the first terminal device in the second local network is scheduled to use the global address overlap with each other.

In at least one aspect, the plurality of local networks are connected in series in such a manner that only one of the plurality of local networks closest to the global network is directly connected to the global network. In this configuration, a first local network of the plurality of local networks includes a function of storing timing of address switch made by the first terminal device of one of the plurality of local networks adjacent to the first local network, a function of performing routing in accordance with the timing of address switch made by the first terminal device of one of the plurality of local networks adjacent to the first local network, and a function of acting as a proxy for data communication in response to a request from the first terminal device of one of the plurality of local networks adjacent to the first local network.

According to another aspect of the invention, there is provided a computer program product comprising computer readable instructions that cause the computer to store an address used for communication for a local network and a global address used for communication for a global network, to judge timing for switching between the address for the local network and the global address, to switch between the address for the local network and the global address in accordance with a judgment result of the address switch judgment unit, and control communication using one of the address for the local network and the global address switched by the address switch unit.

With this configuration, it is possible to form a network system reflecting advantages of both of the local and global networks while achieving a high level of security.

According to another aspect of the invention, there is provided an apparatus capable of performing communications. The apparatus is provided with an address storage unit configured to store an address used for communication for a local network and a global address used for communication for a global network, an address switch judgment unit configured to judge timing for switching between the address for the local network and the global address, and an address switch unit configured to switch between the address for the local network and the global address in accordance with a judgment result of the address switch judgment unit.

With this configuration, it is possible to form a network system reflecting advantages of both of the local and global networks while achieving a high level of security.

In at least one aspect, the apparatus includes a communication unit configured to control communication using one of the address for the local network and the global address switched by the address switch unit.

In at least one aspect, the apparatus includes a time information holding unit configured to provide time information. In this case, the address switch judgment unit judges the timing for switching between the address for the local network and the global address in accordance with the time information provided by the time information holding unit.

In at least one aspect, the apparatus includes an information acquisition unit configured to obtain condition information by one of sensing and measuring. In this case, the address switch judgment unit judges the timing for switching between the address for the local network and the global address in accordance with the condition information provided by the information acquisition unit.

According to another aspect of the invention, there is provided a time division routing information management device, which is provided with a routing information storage unit configured to store a plurality of types of routing information to be switched based on time, and a routing control unit configured to control routing using the plurality of types of routing information to be switched based on time stored in the routing information storage unit.

With this configuration, it is possible to form a network system reflecting advantages of the plurality of types routing manners while achieving a high level of security.

In at least one aspect, the time division routing information management device includes a routing information receive and transmit unit configured to transmit routing switch information to and receive routing switch information from at least one external device. The routing exchange information represents a plurality of types of routing information to be switched based on time.

In at least one aspect, the time division routing information management device includes a routing information transmitting unit configured to transmit routing switch information to at least one external device. The routing exchange information represents a plurality of types of routing information to be switched based on time.

In at least one aspect, the time division routing information management device includes a routing information receiving unit configured to receive routing switch information from at least one external device. The routing exchange information represents a plurality of types of routing information to be switched based on time.

In at least one aspect, the routing control unit controls routing considering a current reachable range of data derived from currently used routing information and a near future reachable range of data derived from routing information to be used next time.

According to another aspect of the invention, there is provided a communication system including a plurality of terminal devices. Each of the terminal devices includes a routing information storage unit configured to store a plurality of types of routing information to be switched based on time, and a routing control unit configured to control routing using the plurality of types of routing information to be switched based on time stored in the routing information storage unit.

With this configuration, it is possible to form a network system reflecting advantages of the plurality of types routing manners while achieving a high level of security.

In at least one aspect, each of the terminal devices further comprises a routing information receive and transmit unit configured to transmit routing switch information to and receive routing switch information from the terminal devices, the routing exchange information representing a plurality of types of routing information to be switched based on time.

### BRIEF DESCRIPTION OF THE DRAWINGS

FIG. 1 is a block diagram of an address management device according to a first embodiment of the invention.

FIG. 2 is a flowchart of a judging process to be executed in an address switch judgment unit of the address management device.

FIG. 3 illustrates an example of time division of addresses.

FIG. 4 is a block diagram of an address management device according to a second embodiment of the invention.

FIG. 5 is a time chart illustrating an example of coordination for switching of routing between three terminal devices A, B and C in a sensor network.

FIG. 6 is an explanatory illustration for explaining coordination of switching of routing between multiple networks.

FIG. 7 is an explanatory illustration for explaining a network system in which a network A, a network B, a network C and a gateway G are connected in series in this order.

FIG. 8 shows another example of coordination of networks A, B and C, and a gateway G.

FIG. 9 illustrates a block diagram of an information home appliance according to a third embodiment of the invention.

FIG. 10 shows a block diagram of each of time division routing information management devices according to a fourth embodiment of the invention.

### DETAILED DESCRIPTION OF THE EMBODIMENT

Hereinafter, embodiments of the invention will be described with reference to the accompanying drawings.

An address management device according to embodiments of the invention may be mounted on various types of devices such as an information home appliance and an IC tag. The term “information home appliance” as used herein means various types of home or personal apparatus such as a refrigerator, a vacuum, a microwave oven, a personal computer, a portable terminal device, an audio apparatus, a surveillance camera, meters (e.g., a electricity meter, a gas meter, etc.). The present invention may be applied to a sensor network for managing a building or a facility, or to a home security network for monitoring rooms. If an information home appliance or an IC tag is applied to a sensor network, PUSH type data transmission in which information is transmitted actively from a center to a device or PULL type data transmission in which a device actively reads information from a center is used. In both of the cases, the device needs to be assigned an global address to perform data communication with an external computer.

In the following, an address used to connect a device in a network to the Internet is referred to as a global address, and an address used in a local network (including an ad hoc network based on short-range wireless communication) is referred to as a local address. It is understood that a local network may be applied to a surveillance camera network in which surveillance cameras are connected by wireless or wired communications in a building, and a network using global addresses may be used to connect the surveillance camera network to an external surveillance center.

### First Embodiment

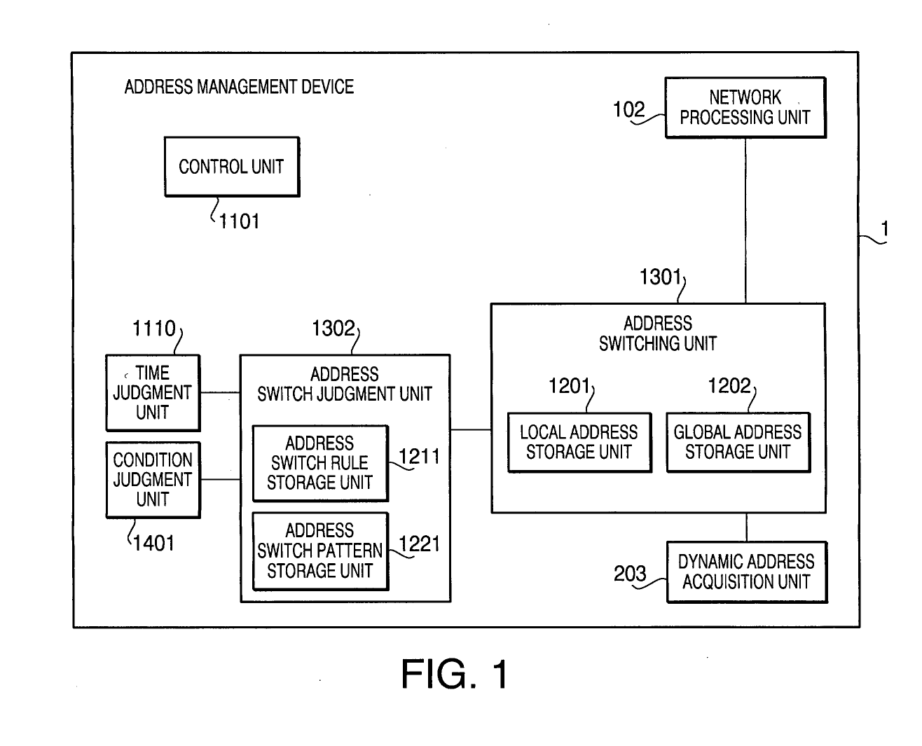

Hereafter, a first embodiment of the invention is described. FIG. 1 is a block diagram of an address management device I according to the first embodiment. The address management device 1 includes a control unit 1101, an address switching unit 1301, an address switch judgment unit 1302, a time judgment unit 1110, a condition judgment unit 1401, and a network processing unit 102. The control unit 1101 controls the condition judgment unit 1401, the address switch judgment unit 1302, the address switching unit 1301, and the network processing unit 102.

The address switching unit 1301 includes a local address storage unit 1201 for storing local addresses and a global address storage unit 1202 for storing a global address. The address switching unit 1301 receives a judgment result from the address switch judgment unit 1302, and makes a selection between a global address and a local address. The network processing unit 102 assigns an address designated by the address switching unit 1301 to an address of the address management device (i.e., an address of a terminal device in which the address management device 1 is mounted).

The address switch judgment unit 1302 includes an address switch rule storage unit 1211 and an address switch pattern storage unit 1221. The address switch rule storage unit 1211 stores information relating to a rule to be used by the address switching unit 1301 for making a selection between a global address and a local address. For example, the rule stored in the address switch rule storage unit 1211 is based on time provided by a time judgment unit 1110, or is based on change of condition judged by the condition judgment unit 1401. The address switch pattern storage unit 1221 stores information on patterns of switching between a global address and a local address. The address switching unit 1301 uses the information in the address switch pattern storage unit 1221 to make a selection between a global address and a local address.

The time judgment unit 1110 obtains a time and sends information regarding the obtained time to the address switch judgment unit 1302.

It should be noted that, in a physical layer of conventional wireless communications or optical fiber communications, a time division multiplex system in which communication channels (e.g., communication frames or communication bands) are divided and are used for various types of purposes has been used. However, the time division multiplex has not been utilized for layers higher than a physical layer, because it is considered that to adjust a time in a network is not easy in regions other than a region (e.g., a region of a physical layer) in which a signal can be managed exactly.

However, for the information home appliance using the near filed communications, it is possible to adjust a time, for example, by broadcasting a time in wireless communication. If a time adjustment is unsuccessful for a certain device, such a device is considered to be located out of the communication range. Therefore, a failure in broadcasting for time adjustment does not badly affect communications in the network based on the short-range wireless communication.

For this reason, the address management device 1 is configured to switch between a global address and a local address based on time information provided by the time judgment unit 1110.

If the address management device 1 is employed in a device in an information home appliance network utilizing the short-range wireless communication, the time judgment unit 1110 may provide time information based on an exact time being broadcast in the network for the address switch judgment unit 1302.

The condition judgment unit 1401 sends an instruction for changing the rule to be used to switch between a global address and a local address, to the address switch judgment unit 1302, in accordance with various types of condition information. The condition information is, for example, warning information, information on external situations, and information regarding detection of network abnormality. The warning information is, for example, information indicating that the network to which the address management device 1 belongs is attacked by an external device, or information indicating that the amount of log of transmission data which is to be sent and is stored in the terminal device in which the address management device 1 is mounted has become large. The information on external situations is, for example, reception of a condition signal by a sensor or reception of emergency information such as disaster radio transmission. The information regarding detection of network abnormality is, for example, a failure of address acquisition by DHCP, or a failure of re-connection after abnormal disconnection from a lower layer.

The condition judgment unit 1401 is able to advance or delay a scheduled time for switching between a global address and a local address. For example, in a network in which more than one address management device I is employed, if a part of the address management devices detect that the network is attacked by an external device, the condition judgment unit 1401 serves to delay the switching time from a local address to a global address so that virus can be detected in the local network and the virus is protected from propagating to a global network.

More specifically, in this case the condition judgment unit 1401 receives warning information (indicating that the network is being attacked by an external device) from another network management device in the network. Then, the condition judgment device 1401 sends out a signal for instruction the address switch judgment unit 1302 not to switch to a global address. After receiving the signal from the condition judgment unit 1401, the address switch judgment unit 1302 operates not to switch to a global address when a scheduled time for switching to a global time is reached.

If the amount of log of transmission data has become large (i.e., warning information regarding resource management is issued), the scheduled switching time for switching to a global address may be advanced. Assuming that the address management device 1 is mounted on a terminal device which is provided with sensors and has the function of collecting detection results of the sensors, in the terminal device logs to be transmitted increases with time. If the condition judgment unit 1401 judges that the amount of log of transmission data has become large, the condition judgment unit 1401 sends out a command signal for instructing the address switch judgment unit 1302 to advance the transmission time at which the log is to be transmitted. After receiving the command signal, the address switch judgment unit 1302 operates to switch to a global address at a time earlier than the previously scheduled switching time.

By such an operation, a situation in which the terminal device becomes unable to transmit logs because of excessively large amount of log accumulated in the terminal device is prevented from occurring, and thereby the log generated in the terminal device is reliably transmitted to the center.

If the condition judgment unit 1401 receives emergency information such as disaster radio transmission, the condition judgment unit 1401 operates to switch to a global address immediately and to transmit information to an external computer. Assuming that the address management device 1 is mounted on a terminal device capable of receiving emergency information from disaster radio transmission, the condition judgment device 1401 provided in the terminal device judges whether emergency information is received. If the condition judgment unit 1401 judges that the emergency information is received, the condition judgment unit 1401 sends a command signal instructing the address switch judgment unit 1302 to switch to a global address. After receiving the command signal, the address switch judgment unit 1302 operates to switch to a global address. By such a configuration, information (which may contribute to disaster relief) held by the terminal device is supplied immediately to the center by global communication.

If a failure of address acquisition by DHCP or a failure of re-connection after abnormal disconnection from a lower layer occurs, the condition judgment device 1401 operates so that a local address is kept unchanged until address acquisition or re-connection is successfully finished. More specifically, the condition judgment unit 1401 checks whether network abnormality such as a failure of address acquisition by DHCP or a failure of reconnection after abnormal disconnection from a lower layer occurs. If network abnormality is detected, the condition judgment unit 1401 sends a command signal instructing the address switch judgment unit 1302 to keep a local address unchanged. After receiving the command signal, the address switch judgment unit 1302 operates so that switching to a global address is not conducted.

Conditions to be detected by the condition judgment unit 1401 are not limited to the above mentioned examples. Environmental conditions surrounding a terminal device employing the address management device 1 or change of network environment to which the terminal device belongs may change the rule of switching between a global address and a local address.

If the rule for switching between a global address and a local address is changed by a judgment result of the condition judgment unit 1401, a global address is resultingly used in a sequence which the center is not able to expect. Therefore, in such a case, the terminal device and the center may become unable to perform PUSH type or PULL type data communication in synchronization with each other. To solve such a problem, the address management device I may be configured to transmit in advance a next switching time for switching to a global address to the center on the global network or to a gate way at the location at which the local network is connected to the global network, based on secret information shared between the terminal device and the center, so that the information on the next switching time can be shared between the terminal device and the center.

More specifically, the address management device 1 transmits information containing a next switching time for switching to a global address according to the address switch rule changed by the judgment result of the condition judgment unit 1401, through the network processing unit 102, as information based on a secret rule shared between the center and the terminal device.

Alternatively, the address management device 1 may set a particular time period (hereafter, referred to as a training time) within which resetting information is allowed to be transmitted through the global network. During the training period, the address management device 1 transmits a particular management signal to an external server (e.g., a centralized management server which serves to monitor pieces of information collected from terminal devices) using a global address, by outputting signals while switching between the local address and the global address at constant time intervals. After the training time period is finished, the address management device 1 immediately turns the address back to the local address. By this configuration, it is possible to transmit information in secret to the external server by representing a next transmission allowable time period, within which the management device 1 would allow the external device to access thereto, in a form of transmission signal intervals.

More specifically, the address switch judgment unit 1302 selects one of address switch patterns, which are used for switching between a local address and global address and are stored in the address switch pattern storage unit 1221, and passes the selected address switch pattern to the address switching unit 1301. Then, the address switching unit 1301 operates to switch between the local address and the global address during the training time, in accordance with the instructions passed from the address switch judgment unit 1302. In a time when the address is kept at the global address, the particular management signal is transmitted to the external server. If a secret key is shared between the terminal device and the center, information (e.g., a next transmission allowable time during which the address management device 1 allows an external device to access thereto) encrypted by the secret key may be transmitted from the terminal device to the center during the training time.

A dynamic address acquisition unit 203 is able to obtain a global address in accordance with DHCP. The dynamic address acquisition unit 203 may operate to obtain a global address by DHCP on an as needed basis without storing in advance the global address.

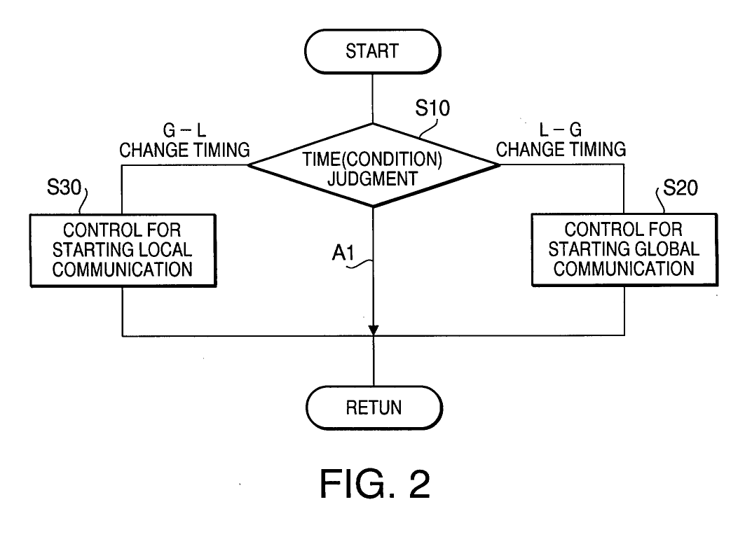

FIG. 2 is a flowchart of a judging process to be executed by the address switch judgment unit 1302. In step S10, the address switch judgment unit 1302 judges whether switch from a global address to a local address or from a local address to a global address, based on information provided by the time judgment unit 1110 and the condition judgment unit 1401 and the rules and patterns stored in the address switch rule storage unit 1211 and the address switch pattern storage unit 1221. If there is no necessity to switch the address, the judgment process may be terminated without executing steps S20 and S30 (see an arrow A1 in FIG. 2). If the address switch judgment unit 1302 judges the address to be switched from a local address to a global address, control proceeds to step S20. In step S20, the address switch judgment unit 1302 sends a global communication start signal to the address switching unit 1301.

If the address switch judgment unit 1302 judges the address to be switched from a global address to a local address, control proceeds to step S30. In step S30, the address switch judgment unit 1302 sends a local communication start signal to the address switching unit 1301. The address switching unit 1301 holds the address (the global address or local address) according to the previous communication start signal. That is, the communication is performed constantly using one of the global and local addresses.

The judgment process shown in FIG. 2 may be executed as a subroutine executed repeatedly in predetermined time intervals (e.g., 0.5 msec intervals).

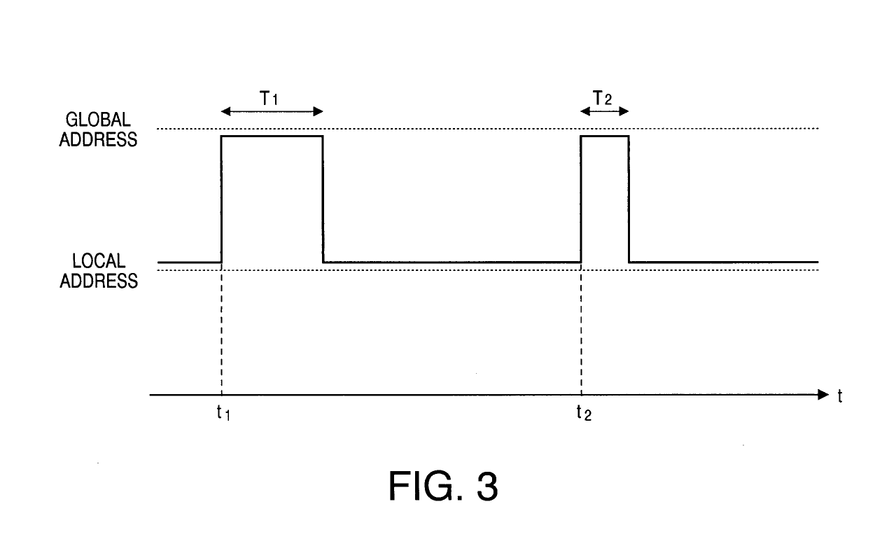

FIG. 3 illustrates an example of time division of addresses. The address management device 1 uses one of global and local addresses. As shown in FIG. 3, in a normal condition, the address management device I uses a local address. The address is switched to a global address in accordance with information provided by the time judgment unit 1110 and the condition judgment unit 1401 and the rules stored in the address switch rule storage unit 1211.

More specifically, at a time t₁, the local address is switched to the global address, and the global address is used in a certain time period T₁. At a time t₂, the local address is switched to the global address, and the global address is used in a certain time period T₂. Such a switching pattern has been stored in the address switch rule storage unit 1211.

An information home appliance incorporating the address management device 1 is able to transmit management information to the center in the time T₁, or T₂ (i.e., to perform PULL type data communication in the time T₁ or T₂), or to receive management information (or warning information) from the center in the time T₁ or T₂ (i.e., to receive PUSH type data communication in the time T₁ or T₂).

### Second Embodiment

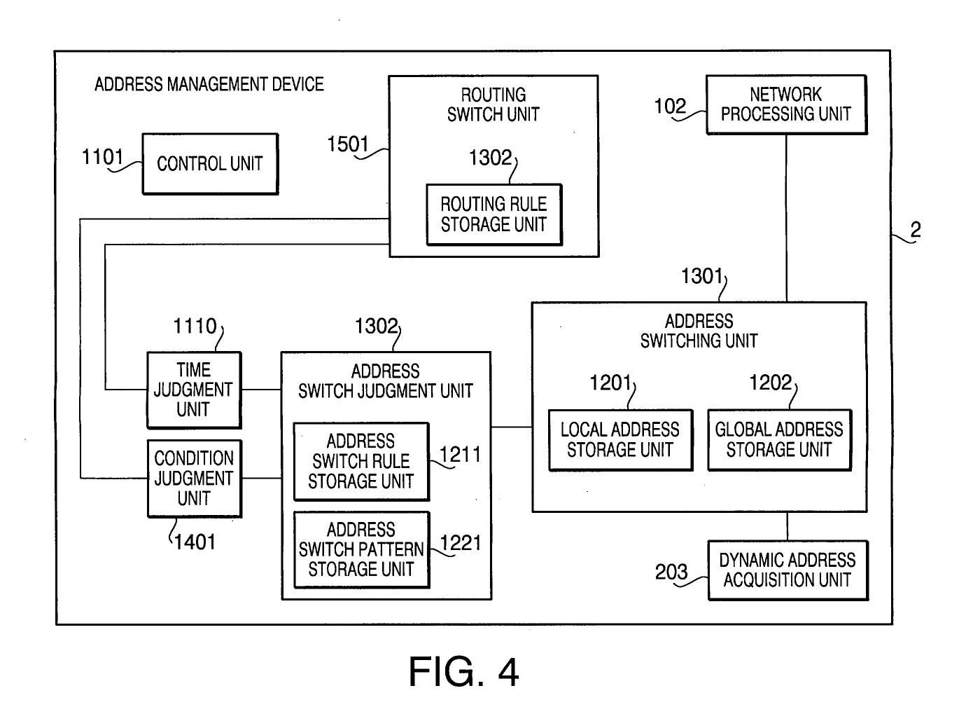

Hereafter, a second embodiment of the invention is described. FIG. 4 is a block diagram of an address management device 2 according to the second embodiment. Since the address management device 2 is configured by adding a routing switch unit 1501 to the address management device I according to the first embodiment, only the feature of the address management device 2 will be described in below. In FIG. 4, to elements which are substantially the same as those of the address management device 1, the same reference numbers are assigned, and explanations thereof will not be repeated.

The routing switch unit 1501 includes a routing rule storage unit 1241 in which information relating to rules used to switch the routing. The rule stored in routing rule storage unit 1241 may be based on time information to be provided by the time judgment unit 1110, or may be based on the condition information to be provided by the condition judgment unit 1401.

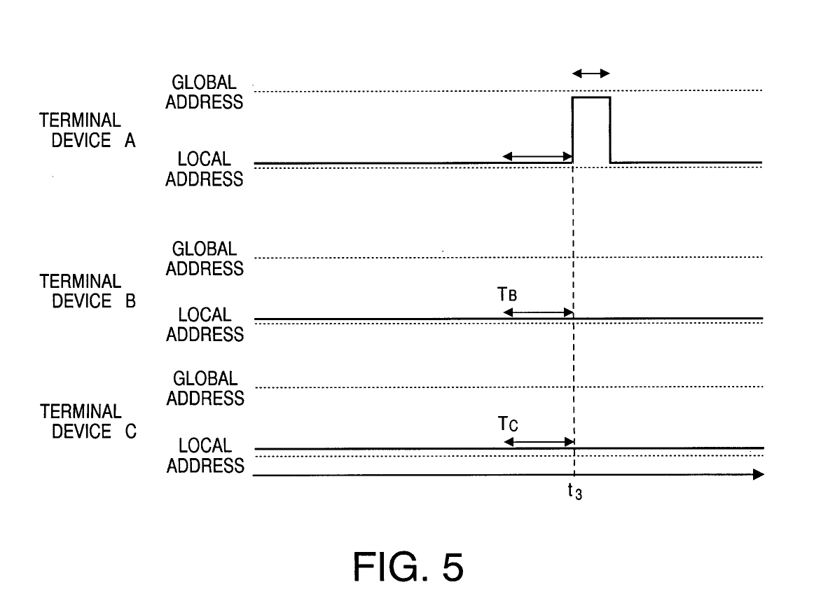

In the following, a sensor network system including multiple terminal devices is considered. In this sensor network, a part of the terminal devices is configured as a device for global communication. Since the terminal devices in the sensor network are able to perform short-range wireless communication in a normal condition, information is gathered in advance in the device for global communication, and thereafter the gathered information is transmitted to an external server through the device for global communication. In FIG. 5, an example of coordination for switching of routing between three terminal devices A, B and C in the sensor network is represented by a time chart.

In the example of FIG. 5, the terminal device A is configured as the device for global communication, and each of the terminal devices B and C is the device for short-range wireless communication. The terminal device A is configured to have one of the address management device 1 and 2. Each of the terminal devices B and C is configured to have the address management device 2 having the routing switch unit 1501. The terminal device A is scheduled to switch to a global address at a time t₃.

Each of the terminal devices B and C is able to connect to the terminal device A and to send information to the terminal device A in accordance with the routing rules stored in the routing rule storage unit 1241. In the example shown in FIG. 5, the terminal device B sends management information during a time period T_{B} before the time t₃, to the terminal device A, and the terminal device C sends management information during a time period T_{C} before the time t₃, to the terminal device A. The information to be transmitted to an external server through the terminal device A may be information relating to home security or building security. By this configuration, it is possible to request the terminal device A to perform transmission of collected information to the external server, for example, owned by a security service company.

Each of the terminal devices B and C is able to change routing rules in accordance with the judgment results of the condition judgment unit 1401. It is understood that if the time at which the address to be used by the terminal device A is switched to an global address due to a judgment result of the condition judgment unit 1401 of the terminal device A, each of the terminal devices B and C needs to match the routing rule with that of the terminal device A so as to transmit information successfully to the external server. For this reason, the condition judgment unit 1401 of each of the terminal devices B and C is configured to obtain information indicating that routing rules has been changed in the terminal device A, and to change routing rule in accordance with the obtained information.

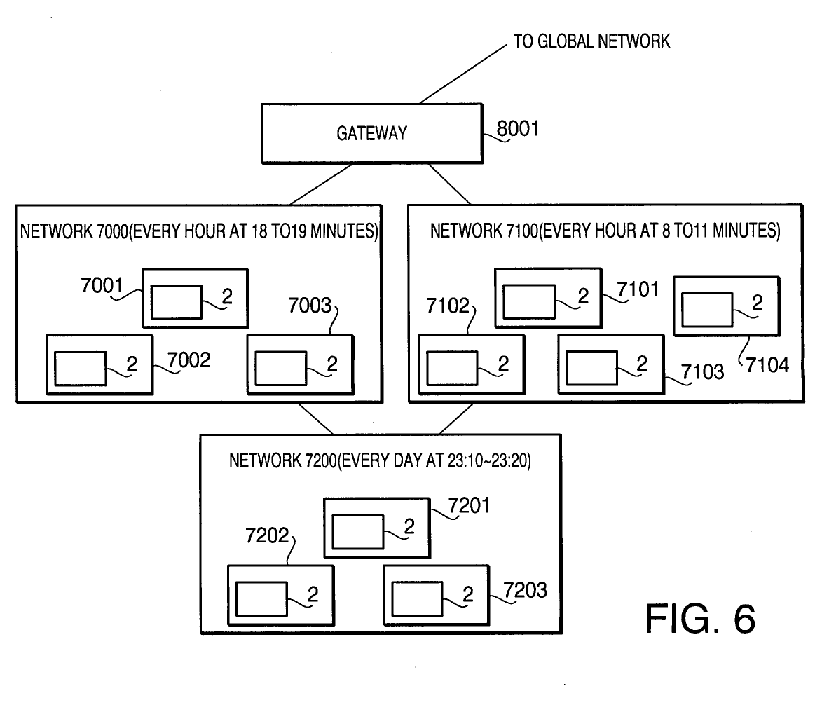

FIG. 6 is an explanatory illustration for explaining coordination of switching of routing between networks. In FIG. 6, networks 7000, 7100 and 7200 are illustrated. Each of the networks 7000, 7100 and 7200 includes at least one device for global communication. More than one device for short-range wireless communication may be provided in each of the networks 7000, 7100 and 7200. For example, each of the networks 7000, 7100 and 7200 may include the terminal devices A, B and C shown in FIG. 5.

Each of the networks 7000 and 7 100 is connected to the global network via a gateway 8001. The network 7200 is indirectly connected to the gateway 8001 via one of the networks 7000 and 7100. The gateway 8001 has a global address used for global communication.

The network 7000 includes terminal devices 7001, 7002 and 7003. The network 7001 includes terminal devices 7101, 7102, 7103 and 7004. The network 7200 includes terminal devices 7201, 7202 and 7203. Each of the terminal devices 7001, 7101 and 7201 has the same function as that of the terminal device A (i.e., includes the address management device 2). The terminal device 7001 is set to use a global address every hour at eighteen to nineteen minutes. The terminal device 7101 is set to use a global address every hour at eight to eleven minutes. The terminal device 7201 is set to use a global address every day at 23:10 to 23:20. Each of the remaining devices (7002, 7003, 7102, 7103, 7104, 7202 and 7203) has the function of the terminal device B or C, and includes the address management device 2.

Since the terminal device 7001 is in a state of using a global address every hour at eighteen to nineteen minutes in the network 7000, the network 7000 is in a state of being able to perform global communication every hour at eighteen to nineteen minutes. The terminal devices 7002 and 7003 are able to send information to the global network by passing the information to the terminal device 7001 in a manner shown in FIG. 5. Therefore, all of the terminal devices in the network 7000 are regarded as being able to perform global communication in the time zone. of eighteen to nineteen minutes every hour.

If a request for transmission of collected data to the center arrives from the terminal device in the network 7100 or 7200, the terminal device 7001 sends the collected information from the terminal device in the network 7100 or 7200, to the center through the gateway 8001.

The network 7100 is in a state of being able to perform global communication in a time zone of eight to eleven minutes every hour. Similarly to the terminal device 7001, if the request for transmission of collected data to the center arrives from the terminal device in the network 7000 or 7200, the terminal device 7101 is able to send the collected data passed from the terminal device in the network 7000 or 7200 to the center in the time zone of eight to eleven minutes every hour.

In the configuration shown in FIG. 6, the network 7200 is able to perform global communication by only sending information via the network 7000 or 7100. If the global communication is routed through the network 7000, the global communication from the network 7200 is allowed only in a time zone during which the transmittable time zone of the network 7000 and the transmittable time zone of the network 7200 overlap with each other. Accordingly, if the global communication is routed through the network 7000, the network 7200 is allowed to perform global communication only in a time zone of 23:18 to 23:19 every day. If the global communication is routed through the network 7100, the network 7200 is allowed to perform global communication. only in a time zone of 23:10 to 23:11 every day.

Since the time zones in which the networks are able to perform global communication are different from each other between the networks 7000, 7100 and 7200, information indicating that the terminal device 7001 moves to a state of being able to perform global communication in a time zone of eighteen to nineteen minutes every hour (i.e., routing rules for instructing each device to send necessary information to the terminal device 7001 before the terminal device 7001 moves to the sate of being able to perform global communication) is stored in the routing rule storage unit 1241 of each terminal device. Similarly, in the routing rule storage unit 1241 of each terminal device, information relating to routing rules for instructing each device to send necessary information to the terminal device 7101 before the terminal device 7101 moves to the sate of being able to perform global communication.

With regard to the global communication from the network 7200, the following information is stored in the routing rule storage unit 1241 of the terminal devices 7202 and 7203. That is, information relating to the routing rules enabling the terminal device 7202 or 7203 to request for the transmission of necessary information to the terminal device 7201 before the time 23:10 at which the global communication through the network 7100 is started, and information relating to the routing rules enabling the terminal device 7202 or 7203 to request for the transmission of necessary information to the terminal device 7201 before the time 23:18 at which the global communication through the network 7000 is started are stored in the routing storage unit 1241 of the terminal devices 7202 and 7203.

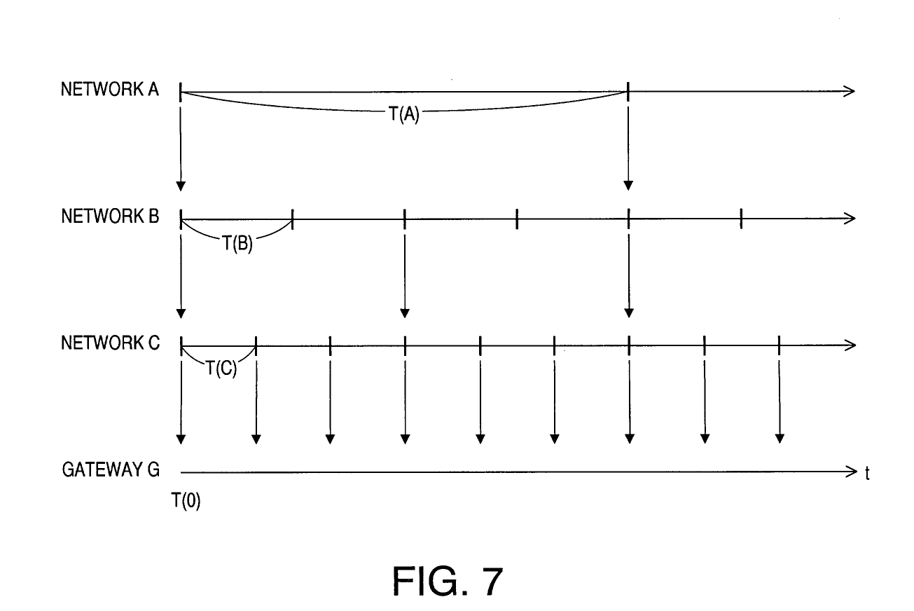

It is understood that by assigning different time division address management manners having different time intervals to networks (e.g., the networks 7000, 7100 and 7200 shown in FIG. 6) and connecting the networks with each other, the networks are able to perform global communication at time intervals corresponding to least common multiple of the different time intervals of all of the networks. Hereafter, the detailed configuration of such networks is explained with reference to FIG. 7.

FIG. 7 is an explanatory illustration for explaining a network system in which a network A, a network B, a network C and a gateway G are connected in series in this order. The (local) networks A, B and C are connected to a global network via the gateway G. The networks A, B and C are configured to be able to perform global communication in one minute at time intervals of T(A), T(B) and T(C), respectively. In this case, the network C is able to be connect to the global network at the time intervals T(C), while the network B is only allowed to connect to the global network at time intervals corresponding to the least common multiple of the time intervals T(C) and T(B), and the network A is only allowed to the global network at times intervals corresponding to the east common multiple of the time intervals T(C), T(B) and T(A). Hereafter, such a configuration is referred to as a cylinder scheme.

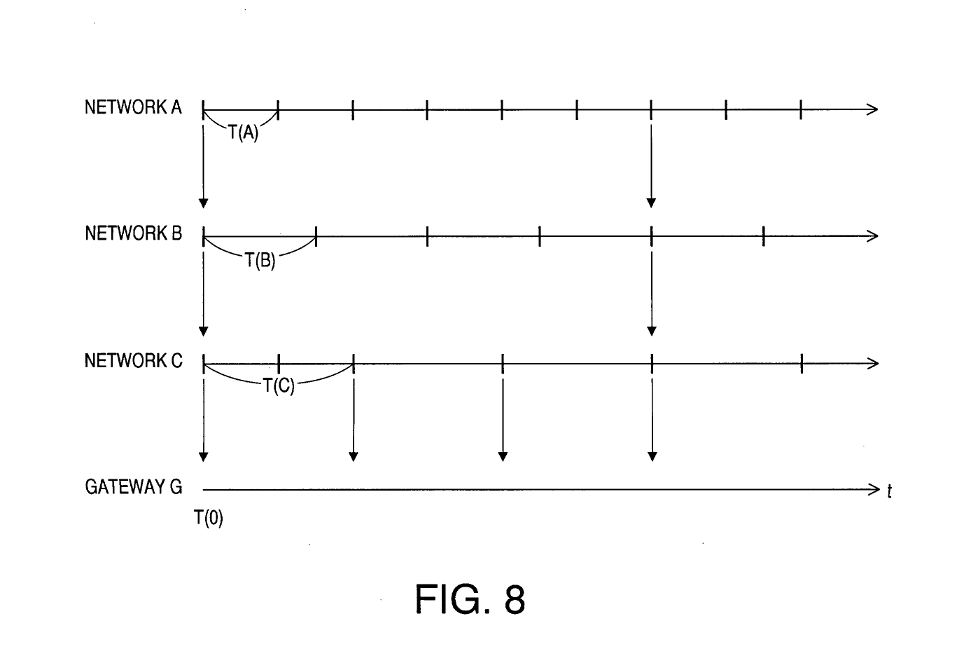

Another example of a network system is shown in FIG. 8. It is understood that if the cylinder scheme is applied to the network system shown in FIG. 8, the network A is able to transmit information to the global network only at time intervals (see arrows extending downward from a line of the network A) corresponding to the least common multiple of time intervals T(C), T(B) and T(A), and the network B is able to transmit information to the global network only at time intervals (see arrows extending downward from a line of the network B) corresponding to the least common multiple of time intervals T(C) and T(B). However, the network A is able to transmit indirectly information to the global network at shorter time intervals (shorter than time intervals corresponding to the least common multiple of time intervals T(C), T(B) and T(A)) by using information representing the time intervals at which the network (B or C) closer to the gateway G than the network A is connected to the global network. Such an advantage is also applicable to the network B. Hereafter, such a configuration is referred to as a bucket relay scheme.

By adopting the bucket relay scheme, each of the networks A and B is able to transmit information to the global network at time intervals equal to the time intervals T(C) at which the network C becomes the global network.

### Third Embodiment

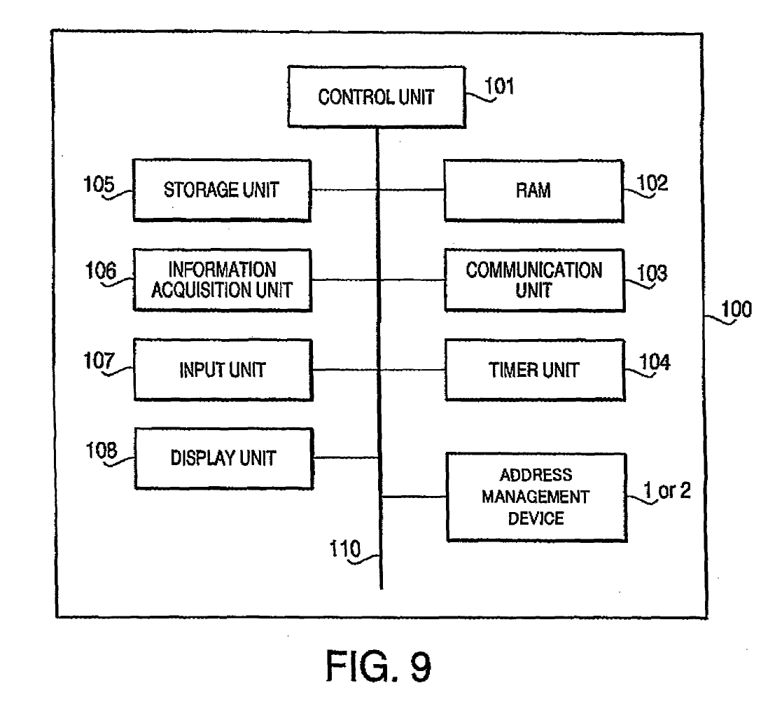

Hereafter, an information home appliance according to a third embodiment of the invention is described. FIG. 9 illustrates a block diagram of the information home appliance according to the third embodiment. For example, the information home appliance 100 is a refrigerator, a vacuum, a microwave oven, a personal computer, a portable terminal device, an audio apparatus, a surveillance camera, meters (e.g., a electricity meter, a gas meter, etc.). In FIG. 9, components relating to the function of network communication are illustrated for the sake of simplicity.

The information home appliance 100 includes a control unit 101, a RAM 102, a communication unit 103, a timer unit 104, a storage unit 105, am information acquisition unit 106, an input unit 107, and a display unit 108. In addition, the information home appliance 100 includes the address management device 1 or 2. The information home appliance 100 may be configured to be supplied with power from a convenience receptacle. Data can be sent and received between the functional units 101 to 108 through a bus 110.

In the RAM 102, various types of data is stored temporarily. The storage unit 105 stores various programs for the functions that the information home appliance 100 is able to provide. The input unit 107 includes a user interface though which a command is inputted by the user. The display unit 108 is, for example, a digital display unit or a monitor on which information relating to the information home appliance 100 is displayed. The information home appliance 100 may be configured not to have the input unit 107 and the display 108.

The communication unit 103 has the function of interfacing the information home appliance 100 with a network, and controls network communications using an address designated by the address management device 1 or 2. That is, the communication unit 103 operates to interface the information home appliance 100 with a local network if an address designated by the address management device 1 or 2 is a local address, while the communication unit 103 operates to interface the information home appliance 100 with a global network if an address designated by the address management device 1 or 2 is a global address.

More specifically, the address management device 1 or 2 of the information home appliance 100 notifies the switch of the address to the communication unit 103 via the network processing unit 102 when the address switching unit 1301 switches the address. If the notification from the address management device 1 or 2 indicates that the address is changed from a local address to a global address, the communication unit 103 operates to interface the information home appliance 100 with a global network. If the notification from the address management device 1 or 2 indicates that the address is changed from a global address to a local address, the communication unit 103 operates to interface the information home appliance 100 with a local network.

The timer unit 104 provides time information through the bus 110 to one of the components shown in FIG. 9. The timer unit 104 may be configured to generate time information using a internal timer circuit or to obtain time information from an external device via the wired or wireless network. The time judgment unit 1110 of the address management device 1 or 2 may be configured to obtain time information from the timer unit 104.

The information acquisition unit 106 has various sensors or measurement devices so as to provide information obtained from the sensors or the measurement devices to one of the components shown in FIG. 9. If the information home appliance 100 is a device for making a temperature adjustment, the sensor of the information acquisition unit 106 may be a thermal sensor. If the information home appliance 100 is a device for detecting a position or a time, the sensor of the information acquisition unit 106 may be a GPS receiver. In another example, an image pick-up device used for a camera, a fuel meter, a voltage meter or a power consumption meter may be employed in the information acquisition unit 106.

Part of information obtained by the information acquisition unit 106 may be used as management information to be transmitted to the center during the time period for the global communication. For example, the center serving to monitor the management information from the information acquisition unit 106 may be configured to detect whether an abnormal condition arises in the temperature or the power consumption of the information home appliance 100.

Part of the information obtained by the information acquisition unit 106 may be used condition information for the condition judgment information 1401 of the address management device 1 or 2.

The information home appliance 100 may be configured not to have control unit 101. In this case, the control unit 1101 of the address management device 1 or 2 may serve to control entirely the internal components shown in FIG. 9.

### Fourth Embodiment

Hereafter, a time division routing information management device according to a fourth embodiment is described.

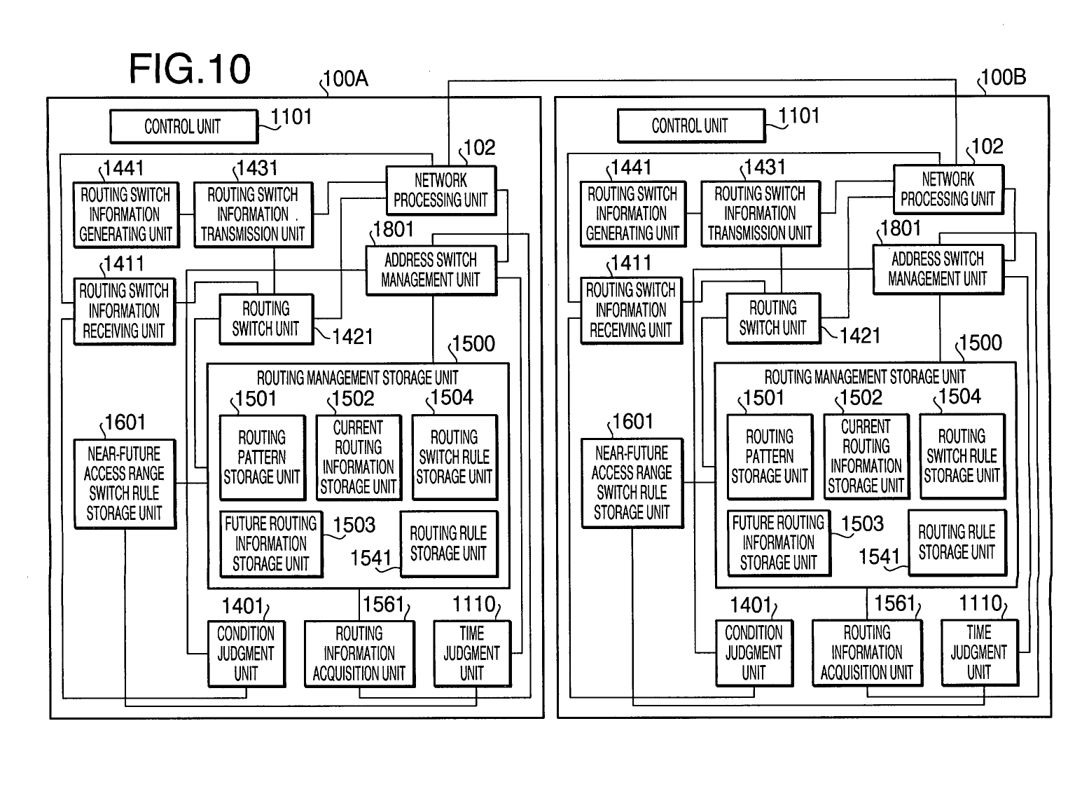

FIG. 10 shows a block diagram of each of time division routing information management devices 100A and 100B. Since the time division routing information management device 100A and 100B have the same configuration, only the configuration of the time division routing information management device 100A (hereafter, frequently referred to as “device 100A”) is explained in detail. In FIG. 10, to elements which are substantially the same as those of the address management device of the first to third embodiments, the same reference numbers are assigned, end explanations thereof will not be repeated.

As described in detain below, the time division routing information management device 100A (100B) is configured to store different types of routing manners (routing information) and to selectively use one of the different types of routing manners in accordance with time or conditions. For example, different types of routing manners respectively assigned to different time zones are stored in the time division routing information management device 100A and are used to switch between the routing manners depending on time. It should be understood that the time division routing information management device 100A may be used in a network system in which a plurality of devices having the same configuration as that of the device 100A are provided.

In FIG. 10, a connection between two time division routing information management devices 100A and 100B is illustrated; however, it is possible to form a communication system in which more than two time division routing information management devices are connected to each other. For example, three time division routing information management devices C, D and E may be connected to the time division routing information management device 100B. In this case, the device 100A needs to request the device 100B to transfer information to the device D in accordance with a routing table in which routing information is described. The device 100B which received data from the device 100A recognizes that the data from the device 100A is addressed to the device D, and then transmits the data to the device D. Finally, the device D is able to receive the data from the device 100A. Such an exchange operation for routing information is carried out under control of a routing information acquisition unit 1561.

The configuration of the time division routing information management device 100A will now be described in detail. The time division routing information management device 100A includes a routing management storage unit 1500 in which a routing pattern storage unit 1501, a current routing information storage unit 1502, a future routing information storage unit 1503, a routing switch rule storage unit 1504, and a routing rule storage unit 1541 are provided.

In the routing pattern storage unit 1501, information on the types of routing manners is stored in advance. In other words, information on how many routing manners the device 100A is able to use is stored in the routing pattern storage unit 1501. For example, the information in the routing pattern storage unit 1501 indicates that three types of routing manners PA, PB and PC exist. For example, the routing manner PA represents a routing manner for local connections using short-range wireless communication, the routing manner PB represents a routing manner for establishing local connections while searching and relaying a connection through a home gateway, and the routing manner PC represents a routing manner for a global connection using a global address.

In addition to the types of routing manners, control information specific to each of the types of routing manners may be stored in the routing pattern storage unit 1501.

The device 100A includes a near-future access range switch rule storage unit 1601 in which information on change of routing manners at a time in the future, a judgment criterion for judging whether the time for change of routing manners is near to the current time, and information on judgment rules to judge whether to handle data to be transmitted if the time for change of routing manners is near to the current time are stored. For example, the judgment criterion for judging whether the time for change of routing manners is near to the current time is “300 ms or fewer” or “15 seconds or fewer”. In this case, if the change of routing manners occurs within 300 ms or 15 seconds, it is judged that the time for change of routing manners is near.

The time judgment unit 1110 is configured to provide time information which is match with the time of other devices (e.g., the devices 100B, C, D and E). The device 100A includes an address switch management unit 1801 in which information on addresses (or a way to obtain addresses) to be used when the routing manner is switched. In the routing rule storage unit 1541, rules on how to select a first relay station if a destination address of a device to which data is to be sent can not be found in a routing table, or rules on how long the device 100A should wait until the device 100A removes information of a node which does nor send a response from the routing table are stored.

In the routing switch rule storage unit 1504, a rule on how to switch the routing manner by considering the prescribed routing manners and routing switch control information which the device 100 receives dynamically are stored.

If the routing switch rule storage unit 1504 judges to switch the routing manner under control of the control unit 1101, the current routing information stored in the current routing information storage unit 1502 is transferred to a memory area for routing information in the future routing information storage unit 1503. In this stage, if new routing information is found in the future routing information storage unit 1503, the new routing information is transferred to the current routing information storage unit 1502. In this stage, a command signal is sent to the address switch management unit 1801 so that the address switch management unit 1801 can switch the address if change of the routing information also requests the change of the address. Such a routing switch operation is carried out under control of a routing switch unit 1421.

A routing switch process is performed as follows. First, the control unit 1101 of the device 100A judges whether routing switch control information from another device has been received. If the routing switch information has not been received, the control unit 1101 reads the rules in the routing switch rule storage unit 1504, and judges whether to send out the routing switch control information. If the control unit 1101 judges to send out the routing switch control information, the control unit 1101 instructs a routing switch information generating unit 1441 to generate routing switch control information.

After generating the routing switch control information, the routing switch information generating unit 1441 sends the generated routing switch control information to a routing switch information transmission unit 1431. The routing switch information transmission unit 1431 converts the routing switch control information to information having a format exchangeable between the devices 100A and 100B, and sends out the converted routing switch control information.

The device 100B is able to receive the routing switch control information through the network processing unit 3102. The received routing switch control information is passed to the routing switch information receiving unit 1411. The routing switch information receiving unit 1411 judges whether to further transfer the received routing switch control information to another device based On the rule stored in the routing switch rule storage unit 1504 as in the case of the device 100A.

The device 100A may be further provided with a user interface for an administrator which allows an administrator to input data regarding routing switch control information to the control unit 1101 through a wired or wireless network, to generate the routing switch control information, and to send out the routing switch control information.

The control unit 1101 is able to obtain the current time from the time judgment unit 1110, to read information corresponding to the current time from the routing switch rule storage unit 1504. If the information corresponding to the current time is found, change of routing manners is conducted.

If the routing switch information receiving unit 1411 has received information for updating the previous settings of routing, the control unit 1101 sends a data (representing the information received by the routing switch information receiving unit 1411) to the condition judgment unit 1401, so that the data is stored. The update of the previous settings of routing is, for example, change of settings of time at a particular date, or setting information for setting time for change of routing by a relative time to an occurrence of a particular event.

If the rule stored in the routing switch rule storage unit 1504 represents switching rules by use of condition information, the control unit 1101 sends a signal to the condition judgment unit 1401 so that the routing switch process is initiated, for example, based on a time defined by the condition information.

With the above mentioned configuration of the device 100A, the device 100A is able to achieve at least the following functions. The device 100A is able to:
send, receive or accumulate more than one routing manners which are different from each other;
exchange routing manners between devices in accordance with a certain information exchange protocol; and
selectively use one of the routing manners (which may be stored in advance in the device 100A, inputted in advance by an administrator to the device 100A, or provided by another device through a network) depending on condition information (e.g., time).

Further, by use of the information in the near-future access range switch rule storage unit 1601, the following operation can be achieved. If the control unit 1101 is able to know the fact that transmission of data to a final destination is impossible through use of the current routing manner, but becomes possible through use of the next routing manner which is to be applied after δt (e.g., 300 ms or 15 seconds), the control unit 1101 is able to postpone the transmission of data until δt elapses. Alternatively, the control unit 1101 may operate to transmit the data to the destination address if δt is so short that the routing manner is expected to change to the next routing manner when a gateway (i.e., a device acting as a gateway for the device 100A) handles the data to be sent to the destination address.

In other words, the device 100A is able to selectively use the routing manner considering the current reachable range of packets and the near future reachable range of packets.

With the above mentioned configuration, it is possible to form a client network (e.g., including information home appliances) having a high security level. It is understood that the above mentioned configuration according to the fourth embodiment is useful in a sensor network and a surveillance system.

1-32. (canceled)

33. An apparatus capable of performing communications, comprising:
an address storage unit configured to store an address used for communication for a local network and a global address used for communication for a global network;
an address switch judgment unit configured to judge timing for switching between the address for the local network and the global address; and
an address switch unit configured to switch between the address for the local network and the global address in accordance with a judgment result of the address switch judgment unit.

34. The apparatus according to claim 33, further comprising a communication unit configured to control communication using one of the address for the local network and the global address switched by the address switch unit.

35. The apparatus according to claim 33, further comprising a time information holding unit configured to provide time information,
wherein the address switch judgment unit judges the timing for switching between the address for the local network and the global address in accordance with the time information provided by the time information holding unit.

36. The apparatus according to claim 35, further comprising a time judgment unit configured to manage time, to receive a time from a wired or wireless network, and to adjust the managed time in accordance with the time received from the wired or wires network,
wherein the time information is provided by the time judgment unit.

37. The apparatus according to claim 33, further comprising an information acquisition unit configured to obtain condition information by one of sensing and measuring,
wherein the address switch judgment unit judges the timing for switching between the address for the local network and the global address in accordance with the condition information provided by the information acquisition unit.

38. The apparatus according to claim 37, wherein the address switch judgment unit judges an address to be changed to the global address for a predetermined time period in accordance with the condition information, and notifies an external device of secret information containing a time at which the address switch judgment unit is scheduled to switch an address to be used to the global address during the predetermined time period.

39. The apparatus according to claim 37, wherein the address switch judgment unit notifies an external device of a time at which the address switch judgment unit is scheduled to switch an address to be used to the global address by repeatedly switching between the address for the local network and the global address at predetermined time intervals in a predetermined time period.

40. The apparatus according to claim 33, further comprising a dynamic address acquisition unit configured to obtain a tentative global address to be used as the global address.

41. The apparatus according to claim 33, wherein the address storage unit includes a first storage unit storing the address used for communication for the local network, and a second storage unit storing the global address.

42. A communication system including a local network in which a plurality of terminal devices having functions of communicating with each other in the local network are provided, the plurality of terminal devices including first and second terminal devices,
wherein the first terminal device includes:
an address storage unit configured to store an address used for communication for the local network and a global address used for communication for a global network;
an address switch judgment unit configured to judge timing for switching between the address for the local network and the global address; and
an address switch unit configured to switch between the address for the local network and the global address in accordance with a judgment result of the address switch judgment unit,
wherein the second terminal device is configured to transmit data for communication for the global network to the first terminal device,
wherein the first terminal device outputs the data from the second terminal device to the global network during a time in which an address to be used is kept at the global address by the address switch unit.

43. The communication system according to claim 42, wherein the second terminal device includes a routing unit configured to perform routing for the first terminal device when the second terminal device transmits the data for communication for the global network to the first terminal device.

44. The communication system according to claim 42, wherein the routing unit performs the routing based on time information.

45. The communication system according to claim 42, wherein the routing unit performs the routing based on condition information.

46. A communication system including a plurality of local networks each of which includes a plurality of terminal devices having functions of communicating with each other in each local network, the plurality of terminal devices including first and second terminal devices,
wherein the first terminal device includes:
an address storage unit configured to store an address used for communication for the local network and a global address used for communication for a global network;
an address switch judgment unit configured to judge timing for switching between the address for the local network and the global address; and
an address switch unit configured to switch between the address for the local network and the global address in accordance with a judgment result of the address switch judgment unit;
wherein the second terminal device is configured to transmit data for communication for the global network to the first terminal device,
wherein the first terminal device outputs the data from the second terminal device to the global network during a time in which an address to be used is kept at the global address by the address switch unit.

47. The communication system according to claim 46, wherein the first and second terminal devices in one of the plurality of local networks transmit data for communication for the global network to the first terminal device in another local network.

48. The communication system according to claim 46, wherein each of the first and second terminal devices in one of the plurality of local networks includes a routing unit configured to perform routing by determining which of the first terminal devices in the plurality of local networks should be targeted for transmission of data for communication for the global network.

49. The communication system according to claim 46,
wherein a first local network of the plurality of local networks is connected to the global network only by intervention of a second local network of the plurality of local networks,
wherein the first terminal device of the first local network is connected to the global network in time zones at which time zones when the first terminal device in the first local network is to scheduled to use the global address and times zones when the first terminal device in the second local network is scheduled to use the global address overlap with each other.

50. The communication system according to claim 46,
wherein the plurality of local networks are connected in series in such a manner that only one of the plurality of local networks closest to the global network is directly connected to the global network,
wherein a first local network of the plurality of local networks includes:
a function of storing timing of address switch made by the first terminal device of one of the plurality of local networks adjacent to the first local network;
a function of performing routing in accordance with the timing of address switch made by the first terminal device of one of the plurality of local networks adjacent to the first local network; and
a function of acting as a proxy for data communication in response to a request from the first terminal device of one of the plurality of local networks adjacent to the first local network.

51. A computer program product comprising computer readable instructions that cause the computer to:
store an address used for communication for a local network and a global address used for communication for a global network;
judge timing for switching between the address for the local network and the global address;
switch between the address for the local network and the global address in accordance with a judgment result of the address switch judgment unit; and
control communication using one of the address for the local network and the global address switched by the address switch unit.

52. A time division routing information management device, comprising:
a routing information storage unit configured to store a plurality of types of routing information to be switched based on time; and
a routing control unit configured to control routing using the plurality of types of routing information to be switched based on time stored in the routing information storage unit.

53. The time division routing information management device according to claim 52, further comprising a routing information receive and transmit unit configured to transmit routing switch information to and receive routing switch information from at least one external device, the routing switch information representing a plurality of types of routing information to be switched based on time.

54. The time division routing information management device according to claim 52, further comprising a routing information transmitting unit configured to transmit routing switch information to at least one external device, the routing switch information representing a plurality of types of routing information to be switched based on time.

55. The time division routing information management device according to claim 52, further comprising a routing information receiving unit configured to receive routing switch information from at least one external device, the routing switch information representing a plurality of types of routing information to be switched based on time.

56. The time division routing information management device according to claim 52, wherein the routing control unit controls routing considering a current reachable range of data derived from currently used routing information and a near future reachable range of data derived from routing information to be used next time.
